(19) United States
(12) Patent Application Publication
(10) Pub. No.: US 2003/0200650 A1
(43) Pub. Date: Oct. 30, 2003

(54) Slider mounting apparatus and method

(75) Inventors: Chester P. Dudek, Marietta, GA (US); Tomonari Yoshida, Marietta, GA (US)

Correspondence Address: KRAMER + ASSOCIATES, P.C., CRYSTAL PLAZA ONE, 2001 JEFFERSON DAVIS HWY. SUITE 1101, ARLINGTON, VA, 22202, US

(73) Assignee: YKK Corporation of America, Marietta, GA

(21) Appl. No.: 10/365,450

(22) Filed: Feb. 13, 2003

Related U.S. Application Data
(60) Provisional application No. 60/375,013, filed on Apr. 25, 2002.

(51) Int. Cl. B29D 5/00

(52) U.S. Cl. 29/766

(57) ABSTRACT

A method and apparatus for attaching a slider to a zipper chain having cords with intervals of zipper teeth along a predetermined length of the cords separated by gaps is disclosed. First the zipper chain is pulled along a predetermined path. A gap in the zipper chain is then detected. Once detected, the zipper chain is substantially stopped. A slider is then held in place in the gap of the zipper chain. Once the slider is in place, resistance is provided as the zipper chain motion is restarted. This causes the cords of the zipper chain to tighten and attach to the slider as the zipper chain moves along the predetermined path.

### REFERENCE TO RELATED APPLICATIONS

This application claims the benefit of U.S. Provisional Application No. 60/375,013 entitled “SLIDER MOUNTING APPARATUS AND METHOD,” filed on Apr. 25, 2002.

### BACKGROUND OF THE INVENTION

1. Field of the Invention

This invention relates generally to an apparatus for attaching sliders to a zipper chain and more particularly to a fully automated method and apparatus for attaching sliders to a zipper chain.

2. Description of Related Art

There are various machines for producing slide fasteners or zippers. Also, there exist several methods for producing assembled zippers for latter attachment to clothing. These zippers are used for shirts, pants, jackets, backpacks, etc. It is advantageous to produce a slide fastener with corded material on both sides and the slider in place. This reduces the overall work necessary to attach a zipper to, for example, the fly on a pair of pants. It is also advantageous to automatically produce these assembled zippers.

One known machine produces a continuous slide fastener chain. U.S. Pat. No. 4,327,470 to Lawrence discloses a method of making a slide fastener installation. A slide fastener installation includes a single unitary sheet of fabric having a slit formed partway therethrough, two trains of slide fastener coupling elements each mounted on the sheet of fabric adjacent an edge of the slit therein, a slider entrained on the trains for engaging and disengaging the coupling elements of the trains, and a layer of adhesive material bonding the respective coupling elements of the trains to the sheet of fabric. Of course, this is only one method of producing a continuous zipper chain. There are other methods well known in the art.

Another machine can be used to produce gaps in a continuous zipper chain. For example, U.S. Pat. No. 4,557,027 to Fisher et al. discloses a slide fastener chain apparatus. The invention is summarized in a slide fastener chain including a pair of coplanar supporting tapes having respective inner longitudinal edge portions, a pair of rows of spaced molded polymer interlocking coupling elements each coupling element having a head and a pair of legs extending from the head, the legs being secured to first sections of the respective inner longitudinal edge portions of the tapes, a pair of rows of spaced pairs of remanents of severed legs of removed coupling elements secured to second sections of the respective inner longitudinal edge portions of the tapes, the legs of the coupling elements protruding substantial distances from respective opposite surfaces of the inner edge portions of the tapes for being engaged by a slider, and the remanents having outer surfaces extending generally parallel to the tapes and generally coplanar with the respective opposite surfaces of the inner edge portions of the tapes. Of course, this is only one method of producing gaps in a continuous zipper chain. There are other methods well known in the art.

Once a gaped, continuous zipper chain is produced, two main tasks remain, attach the slider and cut the zipper to length. Attaching slider is a difficult task that can be achieved by hand through manual labor or through an automated process. Automating the process, however, is very difficult because the zipper teeth and cords must be aligned precisely with the slider. Also, the forces used to attach the slider must be monitored and controlled or else binding occurs which can bind the slider to the zipper chain or interfere with machine operation.

The prior art shows various machines for producing zipper chains and zipper chains with gaps. However, the prior art does show an efficient reliable apparatus or method for attaching sliders to a continuous zipper chain.

Thus, it is an object of the present invention to provide an apparatus for attaching a slider to a continuous zipper chain.

It is another object of the present invention to provide an apparatus that aligns the cords of a zipper chain with a slider to reliably attach the slider to the zipper chain.

It is a further object of the present invention to provide an apparatus that monitors the tension produced in the zipper chain while attaching a slider to the zipper chain.

It is a further object of the present invention to provide an apparatus that controls the tension produced in the zipper chain while attaching a slider to the zipper chain.

It is a further object of the present invention to provide a method of attaching a slider to a zipper chain with reduced binding and machine inefficiencies.

The foregoing objects and advantages of the invention are illustrative of those that can be achieved by the present invention and are not intended to be exhaustive or limiting of the possible advantages which can be realized. Thus, these and other objects and advantages of the invention will be apparent from the description herein or can be learned from practicing the invention, both as embodied herein or as modified in view of any variation which may be apparent to those skilled in the art. Accordingly, the present invention resides in the novel methods, arrangements, combinations and improvements herein shown and described.

### SUMMARY OF THE INVENTION

In light of the present need for providing an efficient reliable apparatus or method for attaching sliders to a continuous zipper chain, a brief summary of the present invention is presented. Some simplifications and omission may be made in the following summary, which is intended to highlight and introduce some aspects of the present invention, but not to limit its scope. Detailed descriptions of a preferred exemplary embodiment adequate to allow those of ordinary skill in the art to make and use the invention concepts will follow in later sections.

An apparatus for attaching a slider to a zipper chain having cords with intervals of zipper teeth along a predetermined length of the cords separated by gaps is disclosed. It includes a working path having a front position and a rear position. Several devices are located along the working path. Feed rollers are aligned in the working path near the front position and are used for pulling the zipper chain through the apparatus. A stopper is located between the front and rear position of the working path and is movable between a go position on the teeth of the zipper chain to a stop position in the gap of the zipper chain. A chain splitter is located near the stopper and is movable from an outside position out of the working path to an inside position in the working path and in the gap of the zipper chain. A slider jig that holds the slider is located near the stopper. The slider jig is movable from a first position out of the working path to a second position in the working path and in the gap of the zipper chain. A tension unit is located near the rear position of the working path and is movable from an engaging position to a disengaging position. The tension unit, in the engaging position, provides a predetermined amount of force to the zipper chain against the feed rollers causing the cords of the zipper chain to tighten and attach to the slider as the zipper chain moves through the apparatus.

A method for attaching a slider to a zipper chain having cords with intervals of zipper teeth along a predetermined length of the cords separated by gaps is also disclosed. First the zipper chain is pulled along a predetermined path. A gap in the zipper chain is then detected. Once detected, the zipper chain is substantially stopped. A slider is then held in place in the gap of the zipper chain. Once the slider is in place, resistance is provided as the zipper chain motion is restarted. This causes the cords of the zipper chain to tighten and attach to the slider as the zipper chain moves along the predetermined path.

### BRIEF DESCRIPTION OF THE DRAWINGS

In order to better understand the present invention, reference is made to the accompanying drawings, wherein:

FIG. 1 shows a flow chart outlining a method of the present invention.

FIG. 2 shows a zipper chain.

FIG. 3 shows a zipper chain with an attached slider and an unattached slider.

FIG. 4 shows a perspective view of an apparatus for attaching a slider to a zipper chain.

FIG. 5 shows a perspective view of the gap detector device.

FIG. 6 shows a side view of the gap detector device before detecting a gap.

FIG. 7 shows a side view of the gap detector device detecting a gap.

FIG. 8 shows a side view of the tension unit and gap detector device.

FIG. 9 shows a side view of the gap detector device and chain splitter.

FIG. 10 shows a top view of the zipper chain, slider, chain splitter and gap detector device interaction.

FIG. 11 shows a front view of the cord damper out of the working path.

FIG. 12 shows a front view of the cord damper in the working path.

FIG. 13 shows a side view of the tension unit and drive unit in working relation.

### DETAILED DESCRIPTION OF THE PREFERRED EMBODIMENTS OF THE INVENTION

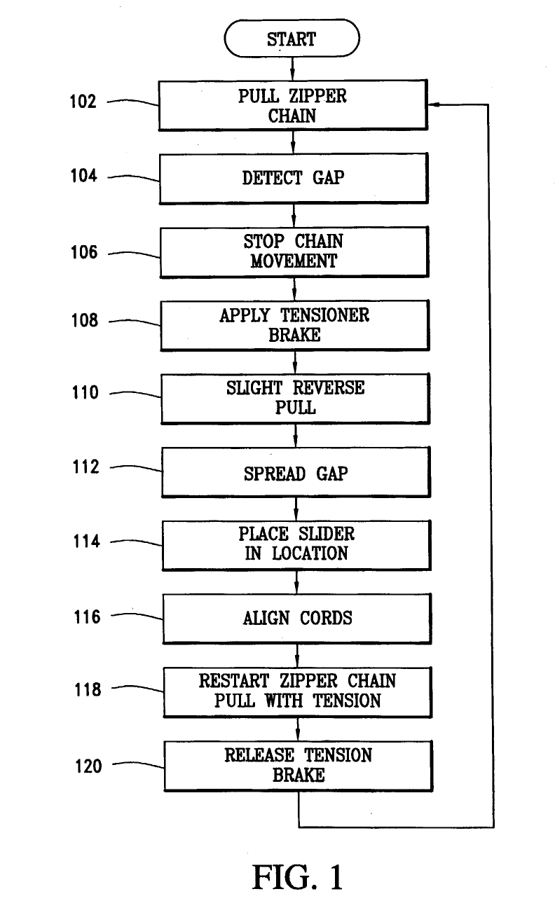

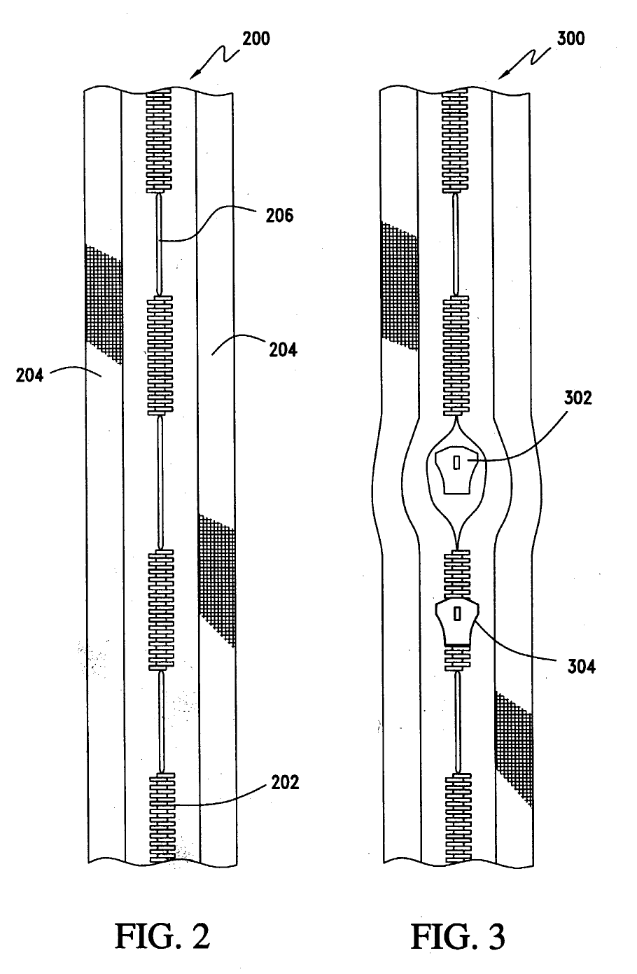

Referring now to the drawings, in which like numerals refer to like components or steps, there are disclosed broad aspects of the preferred embodiments of the present invention. FIG. 1 shows an outline of a method for the present invention that operates on a zipper chain 200, as shown in FIG. 2. The zipper chain 200 includes zipper teeth 202 running along the length of cords 204. The teeth 202 do not run continuously. Before the assembly process is started, gaps 206 are produced in the zipper chain 200. These gaps 206 are the insertion points for installing the slider 302 as shown in FIG. 3.

Referring back to FIG. 1, the zipper chain 200 is pulled through an apparatus, step 102. Gaps 106 in the zipper chain 200 are monitored, step 104. When a gap 206 is detected, the zipper chain 200 is stopped, step 106. After halting the zipper chain 200 movement, a brake is applied from a tension device, step 108. The zipper chain 110 is then moved back slightly from the original direction of pull, step 110. This reversal releases any tension that may have occurred due to the detection of the gap and the stopping of the zipper chain 200, thus allowing the elements to easily separate. Next, the gap 206 is spread and the slider is placed in the proper location, steps 112 and 114 respectively. This arrangement is also shown in FIG. 3. Now the cords 204 of the zipper chain 200 are aligned with the slider 302, step 116. Once alignment is set, the zipper chain 200 is again pulled forward while the brake is in place, step 118. This causes tension in the zipper chain 200 and causes the cords 204 to tighten around the slider 302. The cords 204 are also aligned properly with the slider 302. Due to tension and proper alignment, the zipper chain 200 moving through the apparatus 400 slides onto the slider 302. The brake from the tension device releases and now the attached slider 304 is properly in place along the zipper chain 200, step 120. This is shown in FIG. 3. The entire process restarts with the detection of the next gap 206 in the zipper chain 200.

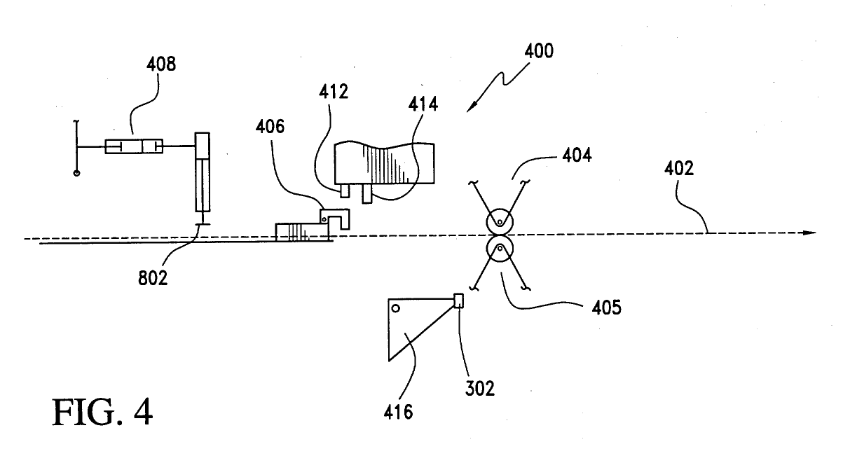

Referring now to FIG. 4, the main features of the apparatus 400 will be described. The apparatus 400 includes a working path 402, one or more idle rollers 404, one or more feed rollers 405, a gap detector device 406, a tension unit 408, a chain splitter 412, a cord damper 414 and a slider jig 416. The working path 402 is shown as the horizontal dotted arrow. The zipper chain 200 substantially follows the working path 402 through the apparatus 400. The working path 402 is separated into a back section, middle section and front section for purposes of description only. In the front section of the working path 402, idle rollers 404 and feed rollers 405 are disposed. The idle rollers 404 and feed rollers 405 engage the zipper chain 200 and provide the main force pulling the zipper chain 200 through the apparatus. Although rollers 404 and 405 are used, any drive means for pulling the zipper chain 200 through the apparatus 400 can be used. This includes a puller, pulleys, a single roller, a plurality of rollers, a reel for winding the zipper chain 200, a hook, a clamp, pneumatically driven devices, intermittent feeders or any known way for pulling web like material through an apparatus.

Also shown in FIG. 4 is the gap detector device 406 in the middle section of the working path 402. The gap detector device 406 details will be described later. However, the gap detector device 406 is responsible for detecting one of the gaps 206 in the zipper chain 200. When a gap 206 is detected, the gap detector device 406 sends a signal to the feed rollers 405 to stop the drive operation.

At this point the zipper chain 200 stops movement and the tension unit 408 is activated. The tension unit 408 will be described in detail later. However, the tension unit 408 is located near the rear section of the working path 402 and includes a brake 802 that engages the teeth 202 of the zipper chain 200. The tension unit 408 is responsible for moving the zipper chain 200 slightly back from the original stop position thus lessening the tension and preventing bundling or kinking in the zipper chain 400 as further operations are performed. The tension unit 408 is also responsible for proving the necessary tension needed when attaching the slider 302 to the zipper chain 200.

Also shown in FIG. 4 are the spreader chain splitter 412 and the cord damper 414 both near the middle section of the working path 402. The spreader chain splitter 412 extends from a position outside of the working path to a position in the working path and cooperates with the arms 502 (gap detector) to spread the gap 206 wider. The cord clamper 414 also extends from a position outside of the working path to a position in the working path and clamps the cords 204 of the zipper chain 200 thus aligning the zipper chain 200 with the slider 302. The slider 302 is brought into position once the gap 206 is spread. The slider jig 416 is responsible for this operation. The slider jig 416 is also located near the middle section of the working path 402 and secures the slider 302 in place during the attachment operation.

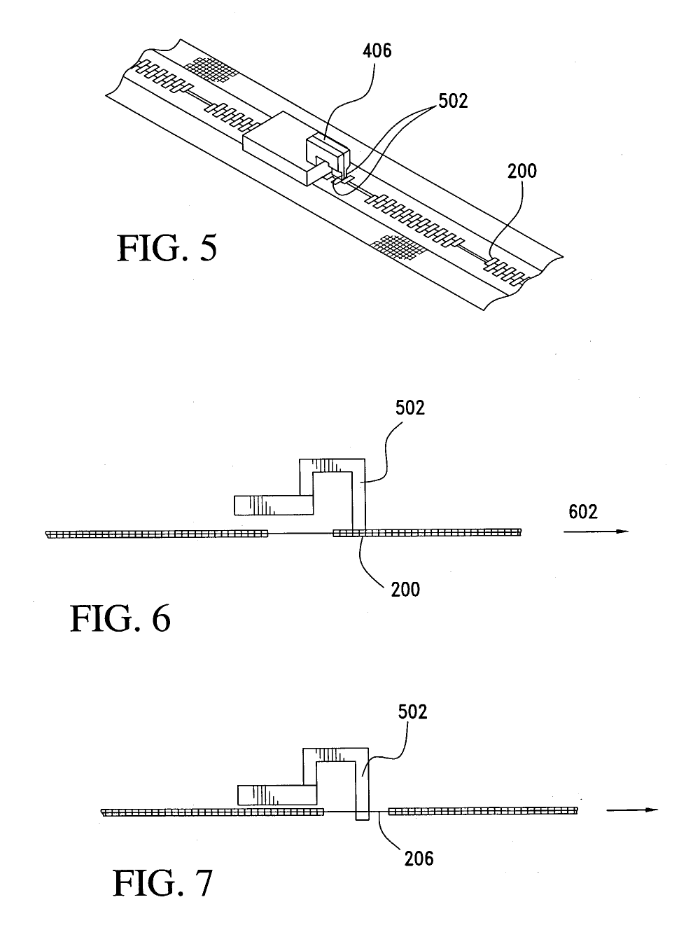

Referring now to FIGS. 5, 6 and 7, the gap detector device 406 is shown and described. The gap detector is primarily two arms 502 that ride along the top surface of the zipper chain 200 as the zipper chain 200 moves along the working path 402. This is clearly shown in FIG. 6. When a gap 26 is encountered, the arms 502 (gap detector) drop into the gap 206 and the circuitry of the gap detector device 406 registers. This is shown in FIG. 7. The circuitry of the gap detector device 406 then sends a signal to the feed rollers 405 to stop pulling the zipper chain 200. A signal is also sent to the tension unit 408, slider jig 416, chain splitter 412, and cord damper 414 to start operations. Most operations from this point are performed in a time-based manner.

The gap detector device 406 shown is just but one means for detecting one of the gaps 206 in the zipper chain 200 and temporarily stopping the feed rollers 405. Several other devices can be used such as a single arm, a camera, an IR emitter and detector, a metal detector, or any other suitable device known in the art.

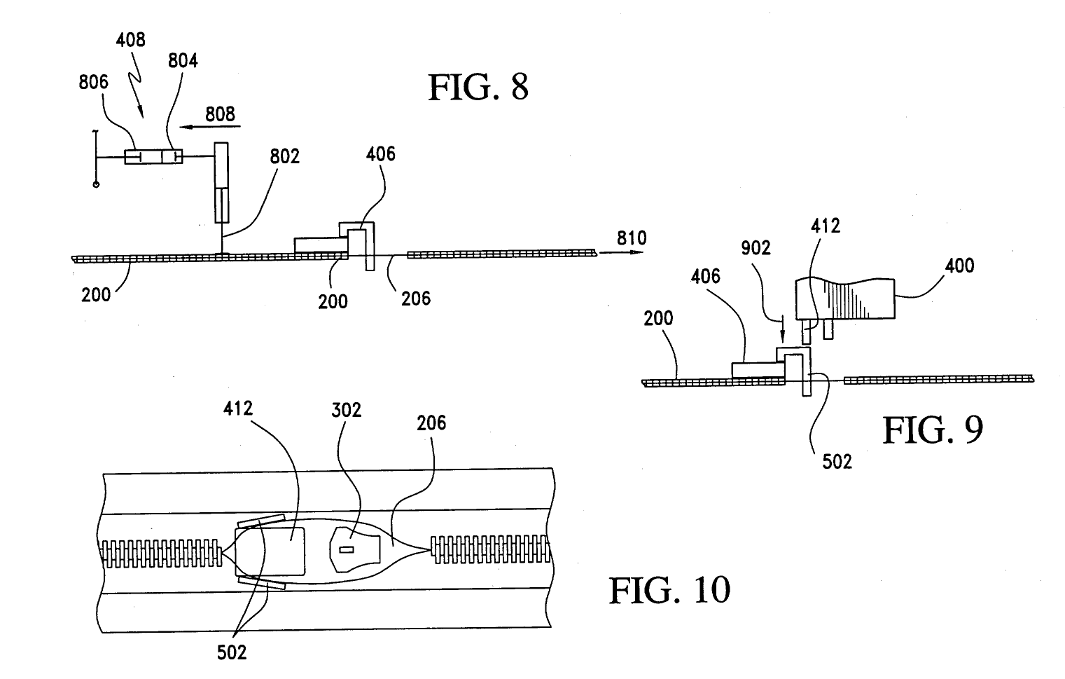

Referring now to FIG. 8, the tension unit 408 and the gap detector device 406 are shown. The tension unit 408 includes a brake 802, a first cylinder 804 and a second cylinder 806. The gap detector device 406 has already detected a gap 206 and the feed rollers 405 have stopped. At this point, the brake 802 is activated. The brake 802 is an air cylinder that forces a rod down onto the zipper chain 200 engaging the teeth 202. The rod can have ridges, points, or a generally rough surface for engaging the teeth 202. The brake 802 can also be mechanically operated, hydraulically operated, spring operated, electromechanically operated, or operated in any known manner. Once the brake 802 has engaged the teeth 202, the first cylinder 804 actuates and moves the zipper chain 200 in the direction of arrow 808. This is the opposite direction of the original drive direction of the feed rollers 405 as shown by arrow 810. The first cylinder 804 is air operated. However, the first cylinder 804 can be mechanically operated, hydraulically operated, spring operated, electromechanically operated, or operated in any known manner. This releases any tension between the teeth 202 near the gap 206 and the gap detector device 406 that may have occurred during the time delay between the gap detector device 406 detecting the gap 206 and signaling the feed rollers 405 to stop.

The tension unit 408 shown is just but one means for providing a predetermined amount of force to the zipper chain 200 against the feed rollers 405. Several other mechanical devices can perform the same function such as feed rollers, regular mechanical brake, spring brake, friction brake, or any other device that can drive or stop a web like substrate.

Referring now to FIG. 9, the chain splitter 412 is shown. The chain splitter 412 interacts with the gap detector device 406 to widen the gap 206 in the zipper chain 200. The chain splitter 412 moves down in the direction of arrow 902 between the arms 502 of the gap detector device 406. The arms 502 are already in the gap 206 and move outwardly as the chain splitter 412 moves between the arms. The chain splitter 412 acts as a wedge moving the arms 502 apart. This widens the gap 206 so that the slider jig 416 can move the slider 302 into place. FIG. 10 shows the widened gap 206 with the slider 302 held in place by the slider jig 416. The top of the chain splitter 412 and the arms 502 also can be seen here.

The chain splitter 412 shown is just but one means for widening the gap 206 in the zipper chain 200. The gap detector device 406 arms 502 can also accomplish this independently. Alternatively, the chain splitter 412 can work independently of the arms 502. In another alternative manner, a reverse force can be placed in the zipper chain 200 to widen the gap.

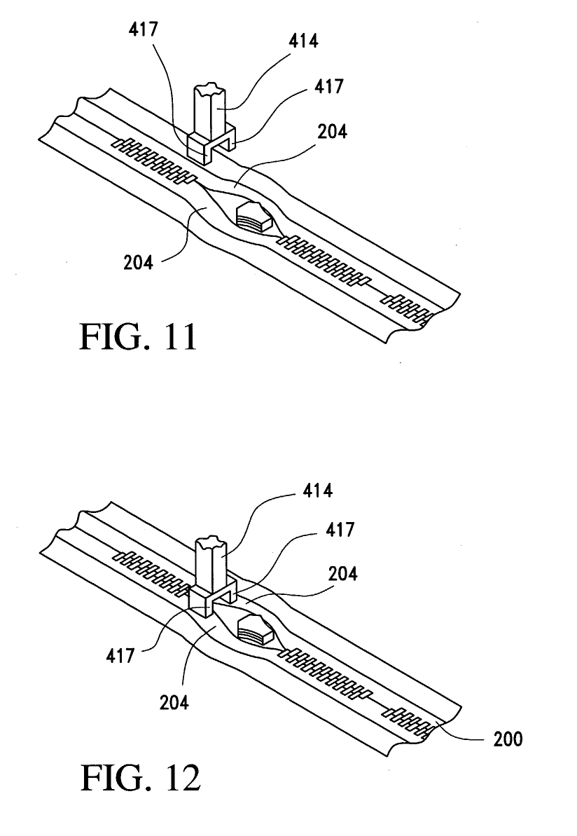

Referring now to FIG. 11, the cord damper 414 is shown retracted out of the working path 402. The cord damper 414 has a general U-shape and includes two descending protrusions 417. These protrusions 417 hold the cords 204 of the zipper chain 200 against the apparatus 400 and directly in line with the slider 302. This reduces any malfunctioning of the machine. When the slider 302 is brought into place, sometimes the cords 204 rest on top of the slider 302 rather than around the outside of the slider 302. This misalignment causes the slider 302 to not attach to the zipper chain 200 as the feed rollers 405 activate. The cord damper 414 reduces the occurrence of this problem by lining up the cords 204 with the middle of the slider 302. FIG. 12 shows the protrusions 417 of the cord damper 414 engaging the cords 204 of the zipper chain 200.

The cord damper 414 shown is just but one means for aligning the cords 204 with the slider 302. The cord damper 414 can have a series of protrusions 417 or can be a roller or any other rigid or semi-rigid guide.

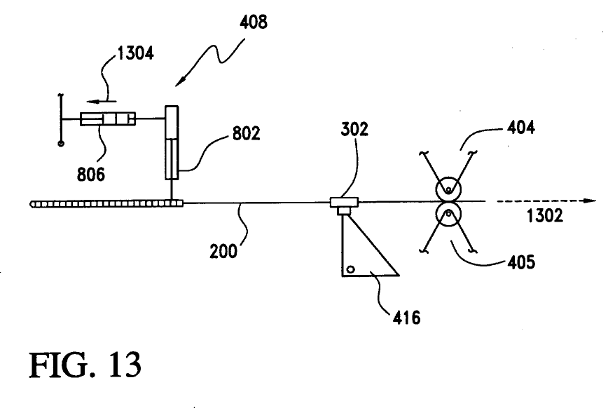

Referring now to FIG. 13, the tension unit 408, slider jig 416, idle rollers 404 and feed rollers 405 are shown. The slider 302 is held in the gap 206 by the slider jig 416 while feed rollers 405 pull the zipper chain 200 in the direction of arrow 1302. Meanwhile, the brake 802 is still engaged. The second cylinder 806 provides tension in the zipper chain 200 by resisting the pull of the feed rollers 405. The second cylinder 806 is an air cylinder and can be precisely controlled to provide a steady resistance, and thus a steady tension in the zipper chain 200. However, the second cylinder 806 can be mechanically operated, hydraulically operated, spring operated, electromechanically operated, or operated in any known manner. This tension causes the cords 204 to constrict around the slider 302 and enter grooves located on the sides of the slider 302. Once the zipper chain 200 has moved a predetermined distance, the slider 302 is assumed to be in place and the brake 802 releases thus restarting the entire operation. The attached slider 304 is shown in FIG. 3.

Although the present invention has been described in detail with particular reference to preferred embodiments thereof, it should be understood that the invention is capable of other different embodiments, and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only, and do not in any way limit the invention, which is defined only by the claims.

What is claimed is:

1. An apparatus for attaching a slider to a zipper chain having cords with intervals of zipper teeth along a predetermined length of the cords separated by gaps, comprising:
a working path having a front position and a rear position;
a puller near the front position for pulling the zipper chain through the apparatus;
a stopper located on the working path and movable between a go position on the teeth of the zipper chain to a stop position in the gap of the zipper chain;
a chain splitter located between the front and rear position of the working path and movable from an outside position out of the working path to an inside position in the working path and in the gap of the zipper chain;
a slider jig holding the slider and located between the front and rear position of the working path, the slider jig movable from a first position to a second position in the gap of the zipper chain;
a tension unit near the rear position of the working path and movable from an engaging position to a disengaging position; and
wherein the tension unit in the engaging position provides a predetermined amount of force to the zipper chain causing the cords of the zipper chain to tighten and attach to the slider as the zipper chain moves through the apparatus.

2. The apparatus of claim 1, further including a cord clamper having two prongs and movable into the working path for engaging and aligning the cords of the zipper chain with the slider.

3. The apparatus of claim 1, wherein the stopper includes two arms resting along the teeth of the zipper chain.

4. The apparatus of claim 3, wherein the chain splitter in the inside position also spreads the two arms of the stopper.

5. The apparatus of claim 1, wherein the tension unit includes a brake pad and friction provides the predetermined amount of force in the engaging position.

6. The apparatus of claim 1, wherein the tension unit includes a brake that engages the teeth of the zipper chain in the engaging position and a resistance device.

7. The apparatus of claim 6, wherein the resistance device is a spring.

8. The apparatus of claim 6, wherein the resistance device is an air cylinder.

9. The apparatus of claim 8, wherein the air cylinder is controlled to provide a constant predetermined resistance.

10. The apparatus of claim 9, further including a second air cylinder for pulling the zipper chain a predetermined distance back from the drive means.

11. An apparatus for attaching a slider to a zipper chain having cords with intervals of zipper teeth along a predetermined length of the cords separated by gaps, comprising:
drive means for pulling the zipper chain through the apparatus;
stop means for detecting one of the gaps in the zipper chain and temporarily stopping the drive means;
holding means for holding the slider in the gap of the zipper chain;
tension means for providing a predetermined amount of force to the zipper chain; and
wherein the cords of the zipper chain tighten and attach to the slider as the zipper chain moves through the apparatus.

12. The apparatus of claim 11, further comprising:
spreading means for widening the gap in the zipper chain.

13. The apparatus of claim 12, further comprising:
clamping means for aligning the cords with the slider as the slider attaches to the zipper chain.

14. The apparatus of claim 13, wherein the stop means consists of two arms that detect the gap by resting against the zipper chain moving through the apparatus until the arms fall into the gap.

15. The apparatus of claim 14, wherein the spreading means consists of a chain splitter that is inserted between the two arms spreading the arms and thus the gap.

16. The apparatus of claim 15, wherein the tension means consists of a brake pad engaging the zipper chain.

17. The apparatus of claim 15, wherein the tension means consists of a brake engaging the teeth of the zipper chain and a resistance device.

18. The apparatus of claim 17, wherein the resistance device is a spring.

19. The apparatus of claim 17, wherein the resistance device is an air cylinder.

20. The apparatus of claim 19, wherein the air cylinder is controlled to provide a constant predetermined resistance.

21. The apparatus of claim 19, further including a stop adjustment means for pulling the zipper chain a predetermined distance back from the drive means.

22. The apparatus of claim 21, wherein the stop adjustment means is an air cylinder.

23. A method for attaching a slider to a zipper chain having cords with intervals of zipper teeth along a predetermined length of the cords separated by gaps, comprising:
pulling the zipper chain along a predetermined path;
detecting one of the gaps in the zipper chain;
substantially stopping the zipper chain;
holding the slider in the gap of the zipper chain;
providing a resistant force on the zipper chain opposite the force caused from pulling the zipper chain along the predetermined path; and
wherein the resistant forces causes the cords of the zipper chain to tighten and attach to the slider as the zipper chain moves along the predetermined path.
